(19) United States
(12) Patent Application Publication
(10) Pub. No.: US 2024/0140061 A1
(43) Pub. Date: May 2, 2024

(54) PROCESS AND ARRANGEMENT FOR MANUFACTURING A BOARD ELEMENT COMPRISING CAVITIES

(71) Applicant: Ceraloc Innovation AB, Viken (SE)

(72) Inventor: Per Josefsson, RAMLÖSA (SE)

(73) Assignee: Ceraloc Innovation AB, Viken (SE)

(21) Appl. No.: 18/495,918

(22) Filed: Oct. 27, 2023

(30) Foreign Application Priority Data
Oct. 28, 2022 (SE) 2251248-7

(51) Int. Cl. B29D 99/00; B29C 43/22; B29C 43/48; B29C 43/52; B29C 71/02; B32B 3/30; B32B 7/12; B32B 27/08

(52) U.S. Cl. CPC B29D 99/0014; B29C 43/222; B29C 43/48; B29C 43/52; B29C 71/02; B32B 3/30; B32B 7/12; B32B 27/08; B29C 2043/483; B29K 2101/12

(57) ABSTRACT

A process for manufacturing a board element including a thermoplastic material, wherein a rear side of the board element includes a cavity region. The process includes shaping a first material in shaping units of a shaping member, wherein the first material includes a thermoplastic material, heating the first material, and hardening the shaped first material for forming protrusions in a rear side of a substrate, wherein the substrate includes a second material including a thermoplastic material. Thereby a board element including the cavity region created between the protrusions is obtained.

### CROSS REFERENCE TO RELATED APPLICATIONS

The present application claims the benefit of Swedish application no. 2251248-7, filed on Oct. 28, 2022. The entire contents of Swedish application no. 2251248-7 are hereby incorporated herein by reference in their entirety.

### TECHNICAL FIELD

The disclosure generally relates to a process and an arrangement for manufacturing a board element comprising a thermoplastic material, wherein a rear side of the board element comprises a cavity region. The disclosure also relates to the board element, such as a panel, per se. The panel may be a building panel, floor panel, wall panel, ceiling panel, or furniture component.

### BACKGROUND

The weight of panels, such as floor panels, may be reduced in a variety of ways. WO 2013/032391 and WO 2014/007738 disclose panels comprising a thermoplastic material that are provided with a certain groove structure in their rear sides for decreasing their weight. The groove structure may be formed by removing material from the rear sides, for example with rotating jumping tools or knives. Improved methods of forming such grooves by a processing tool are disclosed, e.g., in WO 2020/180237 and WO 2022/050891.

There may be scenarios in which it may be advantageous to form grooves, or, equivalently cavities, without any removal of material. For example, and as disclosed in WO 2013/032391, they may be formed when the panel is pressed, such as in a discontinuous press, by extrusion as disclosed in WO 2021/018918, or by impression as disclosed in WO 2021/180882 and PCT/SE2023/050596. However, at least in some applications, there is risk that internal stresses may be formed in the board element when impressing material for forming the cavities. For example, this may negatively impact the dimensional stability of the board element. Furthermore, the process of forming cavities by impression may at least in some applications involve numerous operations, which must be coordinated in a precise manner.

### SUMMARY

It is therefore an object of at least embodiments of the present disclosure to provide a more efficient process for forming a cavity region in a board element.

Another object of at least embodiments of the present disclosure is to provide a weight-reduced board element, while improving its stability and/or its balancing properties.

It is also an object to provide a corresponding an arrangement for manufacturing a board element.

An additional object is to provide an improved board element comprising a cavity region, optionally being manufactured in accordance with embodiments of the process described herein.

These and other objects and advantages that will be apparent from the description have been achieved by the various aspects, embodiments and examples described below.

In accordance with a first aspect of the disclosure, there is provided a process for manufacturing a board element comprising a thermoplastic material, wherein a rear side of the board element comprises a cavity region. The process comprises shaping a first material in shaping units of a shaping member, wherein the first material comprises a thermoplastic material, heating the first material, and hardening the shaped first material for forming protrusions in a rear side of a substrate, wherein the substrate preferably comprises a second material comprising a thermoplastic material. Thereby a board element comprising the cavity region created between the protrusions is obtained.

By means of the first aspect, a cavity region may be created in a board element by forming protrusions from a first material comprising a thermoplastic material. For example, the protrusions may be formed by fusion or moulding. In other words, the cavity region may be created without the need of removing or distributing substantial amounts of material, or at least distributing material in a loose configuration, such as in the form of a granulate, pellets, powder, or particulate. Consequently, the manufacturing process may become more efficient and/or less time consuming.

By having the cavity region and the protrusions, a varying thickness of the board element may be provided, which may reduce the weight of the board element as a whole, for example in comparison with a corresponding board having a uniform thickness corresponding to a thickness of a board element manufactured in accordance with the first aspect at the location of the protrusions.

The forming of protrusions may induce less tension in the board element. Therefore, an improved stability and/or improved balancing properties may be provided.

The first material may be caused to conform to the shaping units, and therefore a shape of the formed protrusions may substantially correspond to a shape of the shaping units.

The steps of shaping and heating in first aspect may be performed in any order, or even simultaneously, preferably being followed by the step of hardening.

The cavity region may comprise at least one cavity, preferably a plurality of cavities. A cavity may be created adjacent to a protrusion and/or between protrusions. Throughout the present disclosure, the wording “cavity” may be construed as a recess, groove, depression, notch, indentation, cut, etc. The cavities may be open towards the rear side of the board element.

For simplicity of the presentation herein, reference will often be made to a plurality of cavities and protrusions, a plurality of shaping elements, etc., but is it clear to a skilled artisan that at least one cavity, at least one protrusion, at least one shaping element, at least one protruding element, etc., is included in these statements.

Generally herein, by hardening (or curing) the first and/or second material comprising a thermoplastic material, the first and/or second material may obtain a fixed shape. For example, the first and/or second material may be cooled below a glass-transition temperature T_{g} of the thermoplastic material comprised therein. A cooling of the first and/or second material may provide the hardening.

The substrate may be a layer or may be hardened to form a layer, such as a core, of the board element. Optionally, a décor structure, such as a decorative layer and/or a wear layer, may be attached, such as laminated or adhered, to a front side of the substrate or core. The decorative layer may be a print layer. In some embodiments, a backing layer, such as a balancing layer, may be attached, such as laminated or adhered, to a rear side of the substrate or core.

Optionally, the substrate or core may comprise inner sections of the protrusions. Thereby, the inner sections of the protrusions may comprise the second material and outer sections of the protrusions may comprise the first material.

At least an inner zone of the substrate or core may be substantially shaped as a rectangular parallelepiped, optionally in addition including the inner sections of the protrusions.

The thermoplastic material of the first and/or second material may comprise thermoplastic polymers, such as polyvinyl chloride, PVC, polyethylene, PE, polypropylene, PP, thermoplastic polyurethane, TPU, or polyethylene terephthalate, PET, ethylene-vinyl acetate, EVA, polyamide, PA, polystyrene, PS, polyvinyl acetate, PVAc, polymethyl methacrylate, PMMA, polyvinyl butyral, PVB, polycarbonate, PC, acrylonitrile butadiene styrene, ABS, polyacrylamide, PAM, polybutylene terephthalate, PBT, or chlorinated PVC, CPVC. Generally herein, the thermoplastic material of the first and/or second material may comprise at least one of amorphous polymers and semi-crystalline polymers. The thermoplastic material of the first material may be different from or the same as the thermoplastic material of the second material.

The thermoplastic material of the first and/or second material may comprise a, preferably inorganic or organic, filler. A degree of filler may exceed 40 wt %, preferably exceeding 60 wt %, such as 50-90 wt % or 60-80 wt %.

The filler may comprise, or may be, an inorganic filler, such as a mineral material, for example calcium carbonate (CaCO₃), limestone, such as chalk, talc, fly ash, barium sulphate (BaSO₄), or a stone material, such as stone powder.

The filler may comprise, or may be, an organic filler, such as a wood material, a bamboo material, cork, or rice husks. For example, the wood material may be wood fibres and/or wood dust, and the bamboo material may be bamboo dust.

The degree of filler and/or the type of filler in the first material may be different from or the same as that in the second material.

The first material may comprise a functional filler, for example cork particles, hollow microparticles, such as hollow glass microspheres (glass bubbles), fibers, such as organic fibres or inorganic fibres, or rubber particles. Further embodiments of the functional filler are specified in relation to the fourth aspect herein, whereby reference is made thereto.

An amount of thermoplastic polymers, such as PVC, in the first and/or second material may be 10-40 wt %, such as 15-35 wt %.

The amount of thermoplastic polymer in the first material may be different from or the same as that in the second material.

The core may be a rigid core. A degree of plasticizer in the core may be less than 5 wt %, preferably less than 3 wt % or less than 1 wt %, such as from 0 to less than 5 wt % or from 0.1 to less than 1 wt %. The core may be free of plasticizer. The core, such as the rigid core, may have a modulus of elasticity, or Young's modulus E, of 1-10 GPa, such as 2-8 GPa, preferably determined in accordance with ISO 178:2010/A1:2013.

The core may be a flexible core. A degree of plasticizer in the core may exceed 5 wt %, preferably being 5-15 wt %. The core, such as the flexible core, may have a modulus of elasticity, or Young's modulus E, of less than 2 GPa, such as 0.3-1.0 GPa, preferably determined in accordance with ISO 178:2010/A1:2013.

The first material may be heated before and/or during the shaping of the first material in the shaping units. In some embodiments, the first material may be heated after the shaping of the first material in the shaping units.

The first material may be heated to a temperature of 80-295° C. For example, the temperature of the first material may be determined by an infrared thermometer or a thermal imaging camera. The first material may be heated above the glass transition temperature T_{g} of the thermoplastic material of the first material. The first material may be heated below a melting temperature Tₘ of the thermoplastic material of the first material.

The process may comprise applying the first material in the shaping units or on the substrate, such as by scattering (or strewing). The process may further comprise applying pressure to the first material during the shaping and/or during the hardening. The pressure may be applied in a press, preferably comprising a mating member. For example, the press may be a static press or a continuous press. Alternatively, the pressure may be applied by a pair of rollers, one of which may comprise shaping elements.

The applied pressure may be in the range of 0.4-6.0 MPa. For example, the pressure may be a maximally applied pressure.

The process may comprise providing a substrate comprising a second material comprising a thermoplastic material. Preferably, the substrate has a constant thickness, at least in an inner portion of the substrate, but preferably as a whole.

The first material may be fused (or added) to a substrate portion of the substrate by a fusing device included in the shaping member. Thereby, the protrusions may be separately formed from the substrate. In other words, the protrusions may be formed on the rear side. By fusing the first material to the substrate an improved stability and/or improved balancing properties of the board element may be provided.

The fusing of the first material may comprise application of heat and, optionally, pressure to the first material. In the fusion process, the first material may be provided in a visco-elastic state (rubbery state) and may be added and bonded or attached to the substrate portion during hardening thereof.

The substrate portion, such as the entire substrate or such as a rear side of the substrate portion, may be disposed at an elevated temperature when forming the protrusions. Thereby, the creation of the cavity region may become more controlled.

The substrate portion, such as the entire substrate or such as a rear side of the substrate portion, may be provided above a glass-transition temperature T_{g} of the thermoplastic material when forming the protrusions. Thereby, the thermoplastic material may be provided in a visco-elastic state. When the thermoplastic material comprises semi-crystalline polymers, such as PET, the substrate portion preferably is provided below a melting temperature Tₘ of the thermoplastic material.

The process may further comprise elevating a temperature of the substrate portion, such as the entire substrate, from an initial temperature to the elevated temperature. The elevated temperature may be higher than an ambient temperature in which the substrate is provided during the forming of the protrusion and/or higher than an initial temperature of the substrate. For example, the ambient temperature may be 13-40° C., such as 16-26° C. The initial temperature may be a temperature of the substrate that has been acclimatized to the ambient temperature. Alternatively, or additionally, the initial temperature may be a temperature of the substrate before heating of the substrate. For example, the temperature of the substrate (portion), such as the initial or elevated temperature, may be determined by an infrared thermometer or a thermal imaging camera.

The elevated temperature may be obtained by heating the substrate portion. Thereby, the substrate portion may be pre-heated before forming the protrusions.

The elevated temperature may be obtained during a forming of the substrate under heat and, preferably, pressure. Hence, the heat generated for forming the substrate may be used for simplifying the forming of the protrusions thereon.

The elevated temperature may exceed 40° C., preferably being 40-295° C., more preferably 100-295° C. When the second material comprises PVC, and, preferably, a filler, the elevated temperature may be 50-210° C., preferably 60-180° C., more preferably 110-180° C. When the second material comprises PP, and, preferably, a filler, the elevated temperature may be 60-220° C., preferably 70-175° C., more preferably 100-175° C. When the second material comprises PET, and, preferably, a filler, the elevated temperature may be 70-295° C., preferably 110-280° C., more preferably 130-280° C.

The board element comprising the cavity region may be formed by hardening the first and the second material.

The acts of shaping and heating the first material may be included in an act of pressing the first and second materials under heat for forming the substrate and the protrusions. The first and second materials may be pressed under heat in a mould, such as in a single pressing operation. The process may further comprise hardening the second material. Thereby, the cavity region and protrusions may be formed in one piece with the substrate or core.

The shaping member, such as a fusing device or a mould, may comprise a press plate provided with a structured surface comprising the shaping units.

The process may further comprise cooling a front side of the substrate during and/or after the hardening of the first material. By means of the cooling, a well-defined and uniform front side may be provided while a shrinkage of the first material may occur in a lower portion of the substrate, such as the rear side. An inner portion of the cavity region may constitute a non-functional surface and may function as a compensation area for material that shrinks during the cooling.

When the shaping and heating the first material comprise pressing the first and second materials under heat for forming the substrate, the front side may be cooled during and/or after hardening of the first material and the second material.

Alternatively, or additionally, to the cooling of the front side, the process may comprise cooling a lower surface of the protrusions. Thereby, well-defined and uniform portions of the rear side may be provided. Preferably, the front side may be cooled at a lower temperature than the lower surface, preferably 5-45° C. lower, more preferably 5-20° C. lower.

The first and/or the second material may be provided as a granulate, pellets, a powder, or a particulate. Any of these may be provided in dry form. During heating, the granulate, pellets, powder or particulate may melt and the components therein and/or therebetween may be consolidated. Preferably, components of the granulate, pellets, powder or particulate have an extension of 0.3 μm to 10 mm, such as 0.5 μm to 3 mm, at least in one direction, such as in a maximal thickness direction, of the components, preferably in three perpendicular directions. By “components” is throughout the disclosure meant granules of the granulate, individual pellets, particles of the powder, or particles of the particulate. The extension of the granulate, pellets, powder or particulate may be measured by ISO 13320:2020.

The first and second materials may be of different types, such as different types of thermoplastic materials. For example, they may differ by at least one element selected from the group of polymers, a grade, a density, an amount of filler, a type of filler, an amount of additives, and a type of additives. In some embodiments, however, the first and second materials may be of substantially the same type.

By means of the first aspect, it may be easier to form the cavity region into an arbitrary, such as curved or non-linear, shape. This is to be contrasted with, e.g., forming cavities by means of cutting with circular cutting blades or saw blades. For example, curved or non-linearly shaped cavities, e.g., having a waveform, may provide a higher bending stiffness of the board element.

Extensions of protruding elements arranged between the shaping units along a pair of non-parallel, such as perpendicular, horizontal directions may be substantially the same. Thereby, corresponding circumscribed cavities may be formed.

Protruding elements arranged between the shaping units may be horizontally elongated. Elongated cavities may thereby be formed.

The process may further comprise forming the substrate under heat, preferably under pressure and/or by (co-)extrusion. By “(co-)extrusion” is throughout the disclosure meant extrusion (single layer) in an extruder or coextrusion (at least two layers) in a co-extruder. Herein, an extruder or a co-extruder may be shortened as “(co-)extruder” or sometimes only “extruder”.

The process may further comprise attaching a layer to the substrate or board element, such as by lamination or by means of an adhesive. The lamination may include pressing the layer to the substrate or board element, optionally under heat.

The process may further comprise supporting a rear side of the substrate or board element, at least including an inner portion of cavities of the created cavity region, and optionally a lower side or lower surface of the protrusions, during lamination of a layer to the substrate or board element and/or during cooling of the board element, such as of the front side. PCT/SE2023/050596 discloses embodiments of supporting operations on page 7, lines 11-20, which part hereby is explicitly incorporated by reference.

The layer may be a décor structure and/or a backing layer. Alternatively, or additionally, the layer may be a sublayer provided between the décor structure and a core.

In some embodiments, a layer may be attached, such as laminated, to the substrate while forming the protrusions.

The process may further comprise annealing the board element after forming the protrusions. By means of the annealing (or “normalization”), internal stresses in the board element, e.g., after the creation of the protrusions may be reduced. This may be particularly important at sharp sections or corners of the protrusions, where the internal stresses may be particularly high. The annealing may be performed after the heating of the first material. For example, the annealing may be performed after dividing the board element into board members and before further dividing the board members into at least two panels. Thereby, a dimensional stability and/or balancing properties of the board element may increase.

The board element may be provided in the form of a panel or may be dividable into at least one panel, such as at least two panels, wherein each panel is a building panel, floor panel, wall panel, ceiling panel or furniture component. For example, a plank, a slab, and a tile are included as examples of a panel.

The process may further comprise forming at least one chamfer in cavities of the cavity region, wherein each chamfer is disposed between a cavity wall and the rear side or between the cavity wall and a bottom portion of the cavity.

The process may further comprise creating at least one tapering cavity by means of at least one tapering protruding element. Thereby, the at least one tapering protruding element may create a tapering cavity. The tapering protruding element may provide a draft angle. For example, the tapering protruding element may comprise a tapering lateral wall portion and/or a bevel, and the tapering cavity may comprise a tapering cavity wall and/or a chamfer. The material of the substrate may thereby be more easily released from the protruding elements after creating the cavities. Also, the flow of the material when creating the cavities may become better, especially when the substrate portion is disposed at an elevated temperature.

A draft angle between a lateral wall portion of the at least one tapering protruding element and an overall normal direction of the shaping member may exceed 0.5°, such as exceeding 1.0° or even exceeding 3.0°.

The first material may comprise a plasticizer. Thereby, the flow of the heated first material may become better. For example, a degree of plasticizer in the first material may exceed 3 wt %, preferably being 5-15 wt %.

In accordance with a second aspect of the disclosure, there is provided a board element, such as a panel, obtainable by the process according to any of the embodiments of the first aspect.

In accordance with a third aspect of the disclosure, there is provided an arrangement for manufacturing a board element comprising a cavity region, wherein the arrangement comprises a shaping member, such as a fusing device or a mould, comprising shaping units.

In accordance with a fourth aspect of the disclosure, there is provided a panel comprising a rear side. The panel comprises a cavity region provided between protrusions formed in the rear side, wherein the protrusions comprise a first material comprising a thermoplastic material, and a core comprising a second material comprising a thermoplastic material. Preferably, the first and second materials are of different types. However, in some embodiments the first and second materials may be of the same type.

Thereby, as will be further elaborated on below, at least some of the panel characteristics, such as its sound properties, thermal properties, or dimensional strength, may be ameliorated while reducing the weight of the panel.

The first and second materials may comprise different types of thermoplastic materials.

The first and second materials may differ by at least one element selected from the group of polymers, a grade, a density, an amount of filler, a type of filler, an amount of additives, and a type of additives.

The protrusions may be provided below an underside of the core. The underside may be a substantially planar surface.

The first material may comprise a functional filler, for example cork particles, hollow microparticles, such as hollow glass microspheres, fibers, such as organic fibres or inorganic fibres, or rubber particles. The cork particles, microparticles or organic fibres may reduce the weight of the panel and/or may provide thermal insulation of the panel. Moreover, the cork particles or rubber particles may provide sound dampening, such as a vibration absorbing property, and/or impact dampening. Moreover, the cork particles or rubber particles may increase a flexibility of the first material. For example, the rubber particles may be recycled particles.

Generally, the fibres may reinforce the protrusions. Inorganic fibers may provide an increased strength or stiffness of the protrusions and may in some embodiments at least partially balance an upper layer of the panel, such as a reinforcement layer, e.g., for decreasing a cupping thereof. The inorganic fibers may be glass fibers, carbon fibres, steel fibres, or combinations thereof. The organic fibers may be synthetic fibres, such as polymer fibres, polyester fibers, PP fibres, nylon fibres, aramid fibres or polyvinyl alcohol fibres, or natural fibres, such as wood fibers or fibres from rice husks, flax, hemp, bamboo, cotton, sisal, jute or ramie, or combinations thereof.

The first and/or the second material may be formed from a granulate, pellets, a powder, or a particulate.

In some embodiments, the protrusions may be formed by fusion or by moulding, for example as described in relation to the first aspect herein.

A protrusion may be arranged at least partly under a locking device of the panel, such as at least partly directly under a locking device of the panel. For example, the protrusion may be arranged under a strip extending horizontally from a lower portion of the board element.

The cavity region may be provided in an interior of the rear side. The interior may be spaced from a pair of opposite edge portions, such as opposite short edge portions, of the panel, optionally being spaced from all edge portions of the panel.

The panel may further comprise a décor structure, such as a decorative layer and/or a wear layer.

The panel may comprise at least one layer. Any layer, some layers, or each layer of the panel may comprise a thermoplastic material.

Extensions of cavities in the cavity region along a pair of non-parallel, such as perpendicular, horizontal directions may be substantially the same.

Cavities in the cavity region may be horizontally elongated.

Additional embodiments and examples of the second, third and fourth aspects are largely analogous to embodiments and examples of the first aspect, whereby reference is made thereto. For example, the panels according to the fourth aspect may be formed by fusion or moulding.

Additionally, the board element or panel in accordance with any of the first, second, third or fourth aspects, may be a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

Generally, all terms used herein, such as in the claims and in the items in the embodiment section below, are to be interpreted according to their ordinary meaning in the technical field, unless explicitly defined otherwise. All references to “a/an/the [element, device, component, means, step, etc.]” are to be interpreted openly as referring to at least one instance of said element, device, component, means, step, etc., unless explicitly stated otherwise. Reference to one or a plurality of “at least one element”, etc., may shortly be referred to as “the element(s)”.

### BRIEF DESCRIPTION OF THE DRAWINGS

The disclosure will in the following be described in connection to exemplary embodiments and in greater detail with reference to the appended exemplary drawings, wherein:

FIGS. 1a-1b illustrate in side views embodiments of an arrangement for manufacturing a board element comprising a cavity region and its use.

FIGS. 1c-1d illustrate in side views an embodiment of a shaping member and a cooling unit (FIG. 1c) and an embodiment of a board element or panel (FIG. 1d), e.g., manufactured in accordance with the arrangement in any of FIGS. 1a-1b and 2a-2d.

FIGS. 2a-2d illustrate in cross-sectional side views embodiments of a shaping member and its use.

FIGS. 2e-2h illustrate in perspective views (FIGS. 2e-2f) and in related side views (FIGS. 2g-2h) embodiments of protruding elements of a shaping member.

FIGS. 3a-3c illustrate in side views embodiments of an arrangement for manufacturing a board element comprising a cavity region and its use.

FIGS. 4a-4b illustrate in side views embodiments of an arrangement for manufacturing a board element comprising a cavity region and its use.

FIG. 4c illustrates in a cross-sectional side view an embodiment of a shaping member and its use.

FIG. 4d illustrates in a perspective view an embodiment of a composite material, e.g., used as first and second materials in FIG. 4b.

FIGS. 5a-5f illustrate embodiments of a shaping member in a perspective view (FIG. 5a) and a side view (FIG. 5b), an embodiment of a shaping member in a perspective view (FIG. 5c) and a sectional side view (FIG. 5d), and a schematic embodiment of a shaping member in a perspective view (FIG. 5e) and a side view (FIG. 5f).

FIGS. 6a-6c illustrate an embodiment of an inner portion of a shaping press plate in a perspective view (FIG. 6a) and embodiments of a shaping member and its use in cross-sectional side views (FIG. 6b-6c).

FIGS. 6d-6e illustrate in cross-sectional side views embodiments of a board element, e.g., manufactured by the shaping members in FIGS. 6b-6d.

FIGS. 7a-7c illustrate in cross-sectional side views embodiments of a board element.

FIGS. 7d-7f illustrate in (cross-sectional) side views embodiments of a shaping member and its use (FIGS. 7d-7e) and a substrate provided with a cavity region (FIGS. 7d-7f).

FIG. 7g illustrates in a cross-sectional side view an embodiment of a board element.

FIGS. 8a-8e illustrate in a perspective view (FIG. 8a) an embodiment of a board element or panel, and in a top view (FIG. 8b), a bottom view (FIG. 8c) and cross-sectional side views (FIGS. 8d-8e) another embodiment of a board element or panel.

FIGS. 8f-8g illustrate embodiments of a board element or panel in bottom views.

FIGS. 9a-9d illustrate embodiments of a board element or panel in a bottom view (FIG. 9a) and in cross-sectional side views (FIGS. 9b-9d).

FIGS. 9e-9f illustrate in cross-sectional side views an embodiment of a board element (FIG. 9e) and of a panel (FIG. 9f) obtainable from the board element.

FIGS. 9g-9h illustrate in a cross-sectional side view and in a bottom view an embodiment of a board element prepared to be divided into panels.

FIG. 9i illustrates in top views embodiments of conceivable geometries of cavities and/or protruding elements.

FIGS. 10a-10b illustrate flow charts of embodiments of a process for manufacturing a board element.

### DETAILED DESCRIPTION

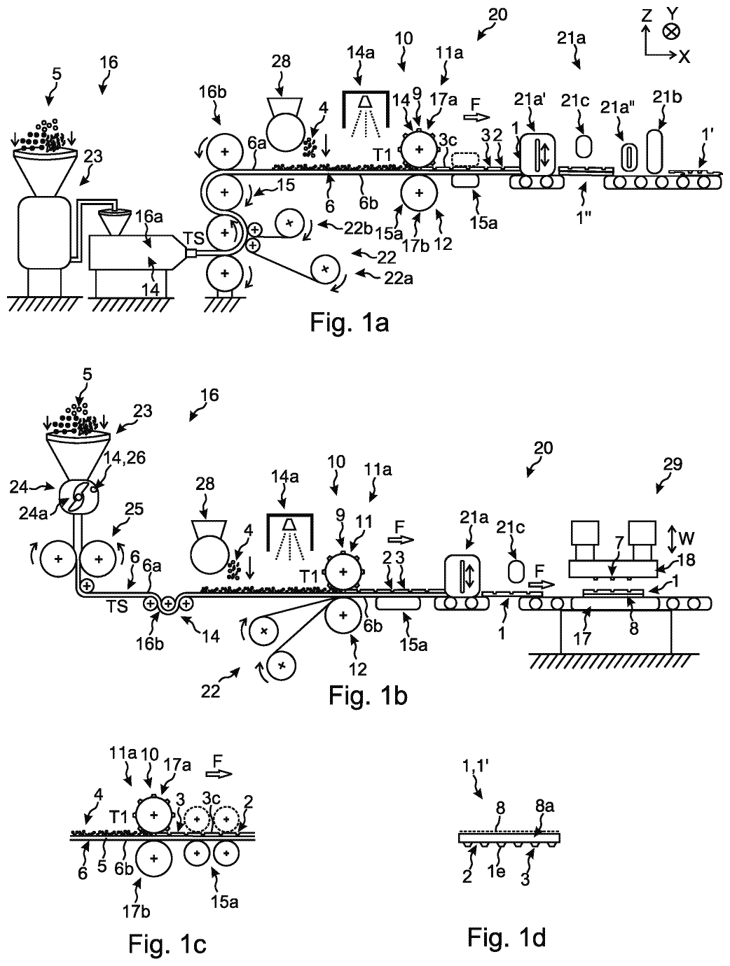

Next, various embodiments of an arrangement 20 for manufacturing a board element 1 comprising a cavity region 2 in a rear side 1e of the board element, as well as embodiments of a related board element, will be described with reference to the embodiments in, e.g., FIGS. 1a-1d, 2a-2h, 3a-3c, 4a-4d, 5a-5f, 6a-6e, 7a-7g, 8a-8g, 9a-9i and 10a-10b. The cavity region 2 may comprise at least one cavity 2′, such as a plurality of cavities 2′. The board element 1 may be rectangular comprising long 1a, 1b and short 1c, 1d edge portions, but other shapes of the board element, such as square, are equally conceivable.

The arrangement 20 extends in a longitudinal X, a transverse Y, and a vertical Z direction. As shown in, e.g., the embodiments in FIGS. 1a-1c, 2a-2d, 3a-3c, 4a-4c, 5a-5f, 6a-6c and 7d-7e, the arrangement 20 comprises a shaping member 10 comprising at least one shaping unit 11, preferably a plurality of them. The shaping member 10 may further comprise a mating member 12. The shaping member 10 may be adapted to press material between the shaping units 11 and the mating member 12.

In some embodiments, protruding elements 9 of the shaping member 10 may be arranged adjacent to and/or between the shaping units 11. The protruding elements 9 may be provided on a base portion 10a of the shaping member and may protrude therefrom in an overall normal direction N of the base portion 10a. Preferably, the protruding elements 9 are separated from each other, such as along one or two perpendicular horizontal directions. A pressing surface 12a of the mating member 12 may be flat and/or smooth. In some embodiments, however, the pressing surface 12a may be structured for providing an embossing 6d in a front side 6b, 1g of the board element 1 or a substrate 6 of the board element 1, such as in a décor structure 8b thereof, cf. FIGS. 1d, 2a-2b, 3b, 8a and 8b.

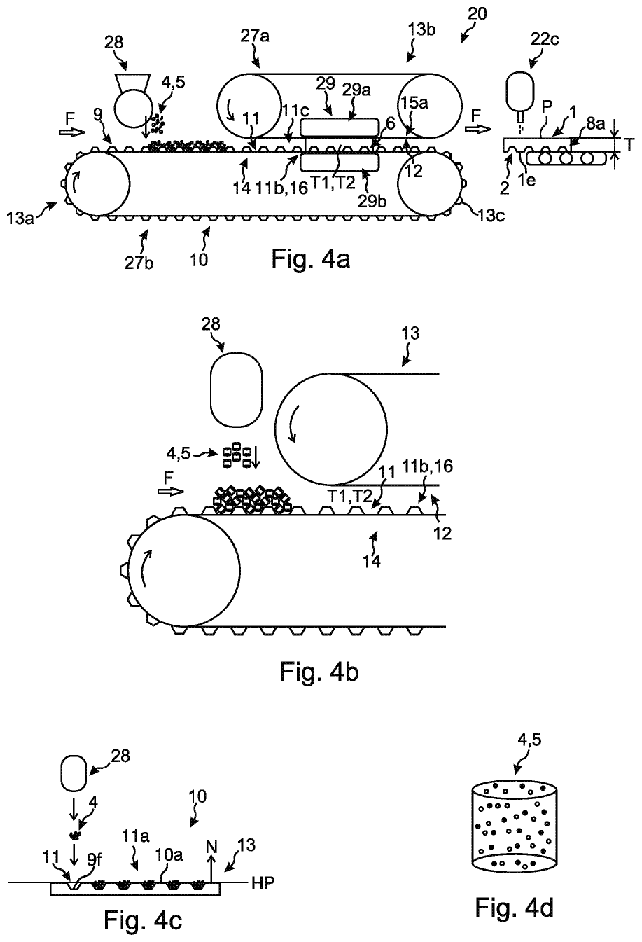

Alternatively or additionally to the protruding elements 9, in some embodiments the shaping units 11 may be formed as lower portions 9f, such as depressions, of the base portion 10a, such as extending inwardly from the base portion 10a (e.g., along the normal direction N), such as inwardly of a horizontal plane HP provided there along, see, e.g., FIG. 4c. This is conceivable in any embodiment herein, such as in FIGS. 1a-1d, 2a-2d, 3a-3c, 4a-4b, 5a-5f, 6a-6c and 7d-7e.

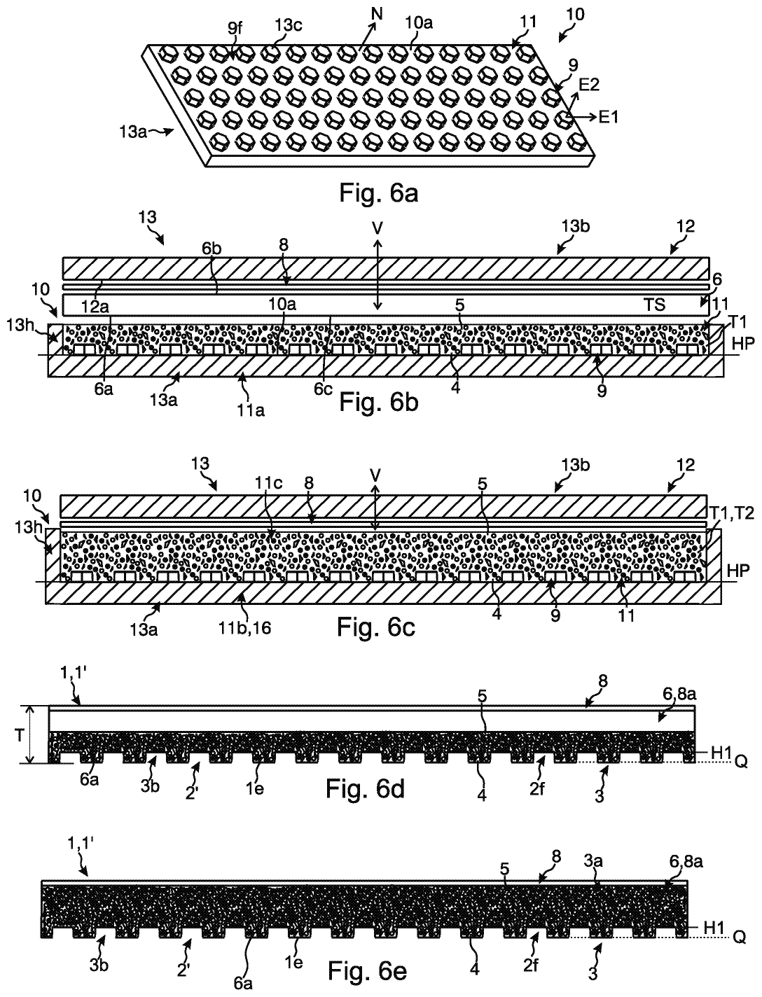

In some embodiments, the shaping member 10 may comprise a fusing device 11a configured to fuse a first material 4 to a substrate portion 6c of the substrate 6 for forming protrusions 3 thereon, cf. FIGS. 1a-1c, 2a-2d, 3a-3c and 6b. In other embodiments, the shaping member 10 may comprise a mould 11b configured to press a first 4 and a second 5 material under heat for integrally forming a substrate 6 and protrusions 3, cf. FIGS. 4a-4b and 6c.

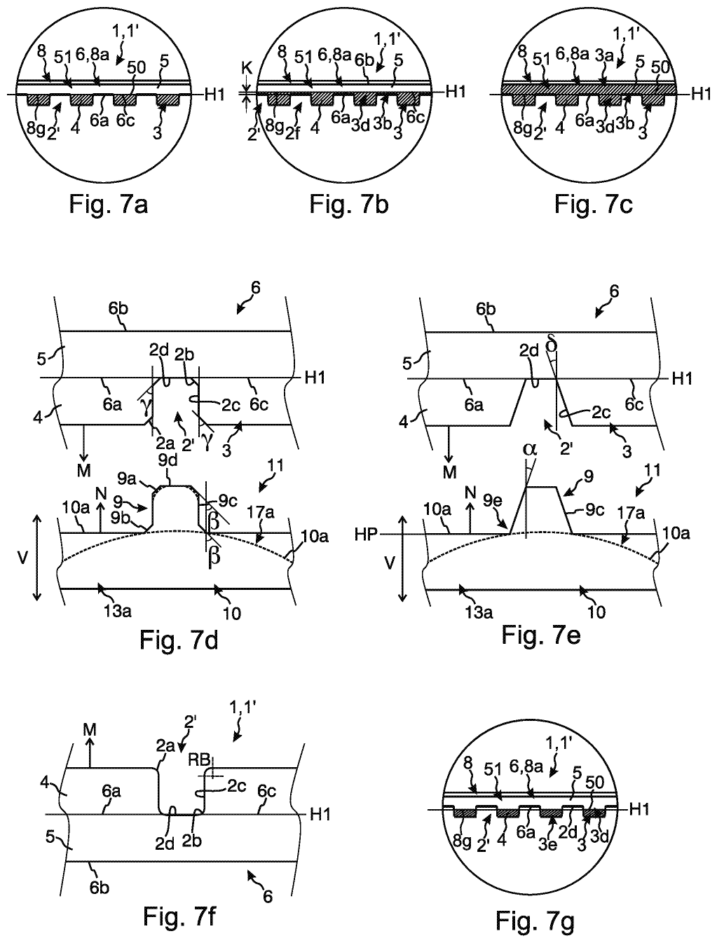

In some embodiments, as shown in, e.g., FIGS. 1a-1c, 5a-5f and 7d-7e, the shaping member 10 comprises at least one roller 17a (see lower broken lines in FIGS. 7d-7e) and the mating member 12 may comprise a mating roller 17b, each roller preferably being rotatably arranged in the arrangement 20. The overall normal direction N may correspond to a radial direction R of the roller, preferably being perpendicular to a circular base portion. The rollers 17a, 17b may be rotatable around a respective axis AX, BX.

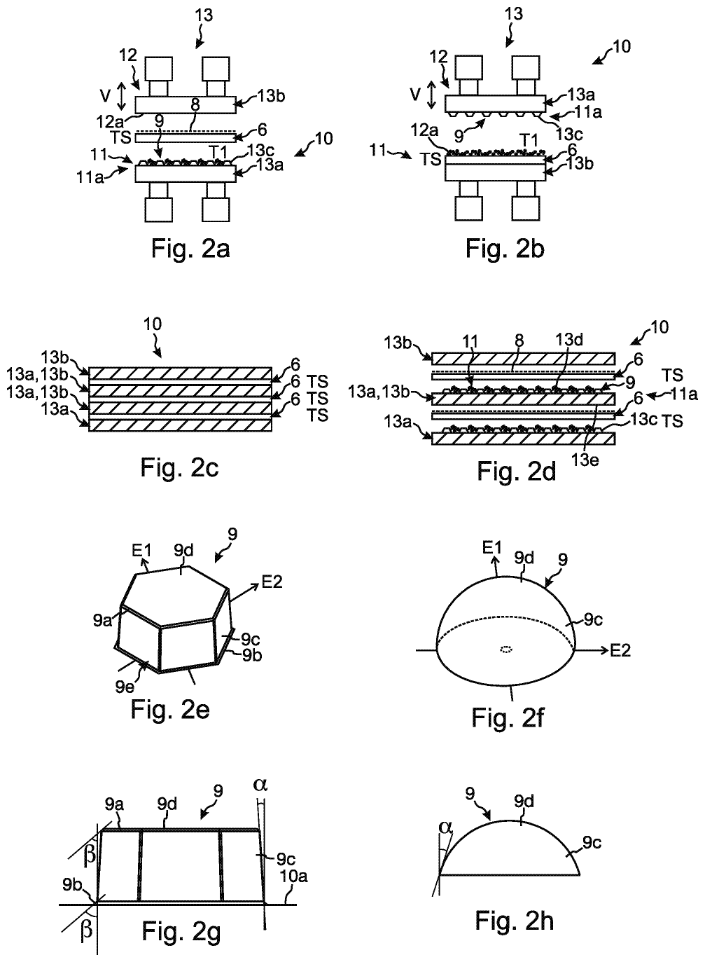

In some embodiments, as shown in, e.g., FIGS. 2a-2d, 3a-3c, 4a-4c and 6a-6c, the shaping units 11 and the mating member 12 are provided in a press plate assembly 13. The shaping and mating members may comprise a shaping press plate 13a provided with a structured surface 13c and a mating plate 13b, respectively. Each shaping unit 11 may include a lower portion 9f of the structured surface 13c. FIG. 6a illustrates an inner portion of the shaping press plate 13a in FIG. 6b or 6c, without side walls 13h. The structured surface 13c may comprise protruding elements 9 and intermediate lower portions 9f, such as depressions, provided therebetween. For example, the structured surface may be part of an embossing plate. The overall normal direction N may be perpendicular to the base portion 10a, such as the horizontal plane HP.

Optionally, the shaping units 11 and mating members 12 may be relatively displaceable with respect to each other along a, for example vertical, direction V.

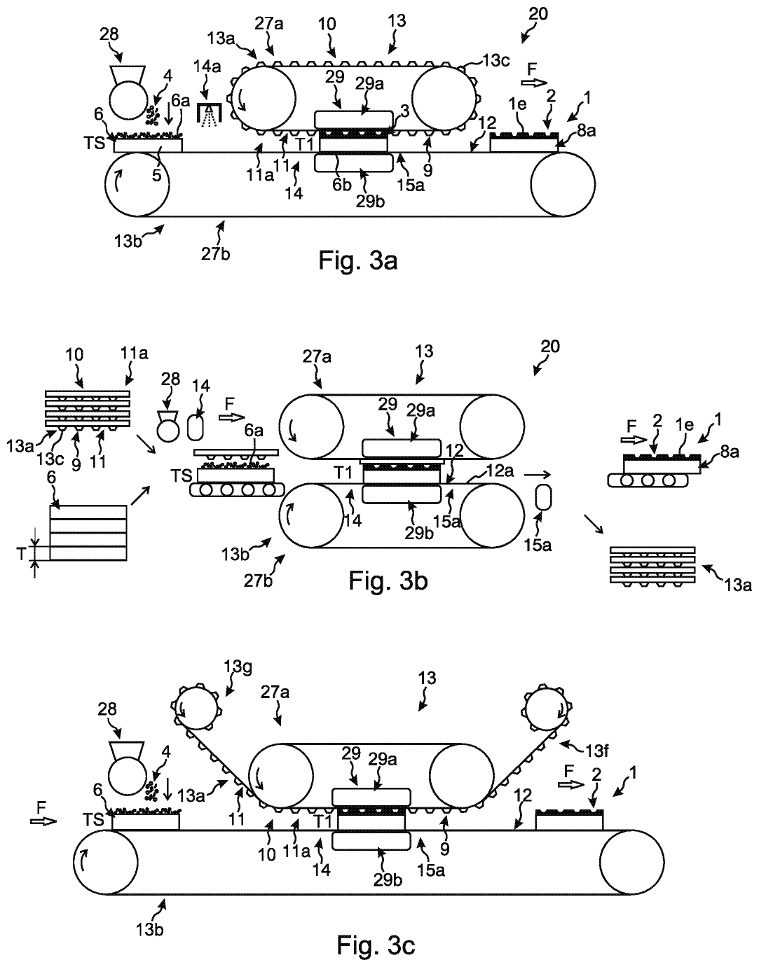

The press plate assembly 13 may be provided in a pressing device, which may be a static press, such as a short-cycle press (see, e.g., FIGS. 2a-2b and 6b-6c) or a multi-daylight press (see, e.g., FIGS. 2c-2d), or a continuous press, such as a double-belt press (see, e.g., FIGS. 3a-3c and 4a-4b). The pressing device may be a fusing device 11a or a mould 11b.

In some embodiments, the static press may comprise at least two shaping press plates 13a, and preferably at least two mating plates 13b, see, e.g., the generic schematic embodiment in FIG. 2c and the more particular embodiment in FIG. 2d. The press plate 13a may comprise protruding elements 9 on a base portion 10a provided on one side 13d of the press plate, see, e.g., FIG. 2d. An opposite side 13e of an interior press plate 13a may form a portion of a mating plate 13b. The substrates 6 may be arranged face-to-back (front-to-rear) in the static press.

As shown in, e.g., FIGS. 1a-1c, 2a-2d, 3a-3c, 4a-4b, 5a-5f and 6b-6c, the first material 4 and/or a substrate 6 in which the cavity region 2 is to be created may be provided, such as fed, between the shaping units 11 and the mating member 12. During a forming of protrusions 3 in the substrate 6, the shaping units and the mating member may be configured to face a rear side 6a and the front side 6b of the substrate, respectively.

The double belt-press may comprise an upper 27a and a lower 27b endless belt unit. The shaping press plate 13a may be provided as a portion of a belt of the upper 27a or lower 27b endless belt unit, see, e.g., FIGS. 3a and 4a-4b. Moreover, the mating plate 13b may be provided as a portion of a belt of the lower 27b or upper 27a endless belt unit, see, e.g., FIGS. 3a-3c and 4a-4b.

In some embodiments, and as shown in FIGS. 3b-3c, a part of the press plate assembly 13 may be provided separately from the double-belt press. The press assembly 13 may comprise a plurality of separate shaping press plates 13a, see, e.g., FIG. 3b, preferably being configured to be reused several times.

In some embodiments, and as shown in FIG. 3c, the shaping member 10 comprises a flexible member 13f comprising the protruding elements 9, preferably being configured to be winded on a reel 13g, for example upstream and/or downstream of the upper endless belt unit 27a.

The shaping member 10 herein, for example the shaping press plate 13a or the flexible member 13f, e.g., in any of FIGS. 1a-1c, 2a-2h, 3a-3c, 4a-4c, 5a-5f, 6a-6c and 7d-7e, may comprise a structured paper, a structured sheet, such as a metal sheet or a phenolic sheet, or a structured foil, such as a polymer-based foil. The metal may comprise steel.

The substrate 6 may be transported from an inlet of the double-belt press to a pressing member 29 thereof. The pressing member 29 may comprise an upper 29a and/or a lower 29b press member configured to apply pressure, and preferably heat, to the first material 4, and optionally a second material 5, for forming the protrusions 3.

The protruding elements 9 in any embodiment herein, such as in FIGS. 1a-1c, 2a-2d, 3a-3c, 4a-4c, 5a-5f, 6a-6c and 7d-7e, may be of frustro-conical form or semi-spherical form, or may be formed as a, preferably rectangular, parallelepiped, a polyhedron, a prismatoid, such as a prism, etc. FIGS. 2e-2h illustrate semi-spherical protruding elements and prismatoid protruding elements. For example, their form may be determined with respect to the base portion 10a.

The protruding elements 9 may be tapering, preferably in a direction away from the base portion 10a, such as in the overall normal direction N. In any of the embodiments herein, such as in FIGS. 1a-1c, 2a-2h, 3a-3c, 4a-4c, 5a-5f, 6a-6c and 7d-7e, a draft angle α between a lateral wall portion 9c of a protruding element 9 and the overall normal direction N may exceed 0.5°, such as exceeding 1.0° or even exceeding 3.0°, cf. FIGS. 2g-2h and 7e. For example, α may be 0.5-70°, such as 0.5-45° or 1-30°. The base portion 10a of a shaping press plate 13a and a roller 17a is shown in FIGS. 7d-7e by an unbroken line and a broken line respectively. In some embodiments, as shown in, e.g., FIGS. 2e, 2g, 5a-5f, 6a-6c and 7d-7e, the lateral wall portion 9c may be substantially planar. Alternatively, as shown in FIGS. 2f and 2h, the lateral wall portion 9c may be curved.

Other types of tapering protruding elements are equally conceivable. In some embodiments, the protruding elements 9 may comprise a bevel, such as an outer 9a and/or an inner 9b bevel, see, e.g., FIGS. 2e, 2g and 7d. The outer bevel 9a may be provided between the lateral wall portion 9c and an outer wall 9d. The inner bevel 9b may be provided in an inner region 9e of the protruding elements 9 adjacent to the base portion 10a. The bevel(s) 9a and/or 9b may be inclined with respect to the overall normal direction N by an angle β. For example, the bevel angle(s) β may be 10-70°, such as 25-40°, for example 45°.

The arrangement 20 may comprise a substrate forming arrangement 16, preferably provided upstream from the shaping member 10, see, e.g., FIGS. 1a-1b, or provided by the mould 11b, see, e.g., FIGS. 4a-4b and 6c. A hardened substrate 6 may provide a core 8a of the board element 1. Optionally, the substrate 6 may comprise additional layers 8, for example obtained from co-extrusion thereof.

As shown in the embodiment in, e.g., FIG. 1a, the substrate forming arrangement 16 may comprise an extruder 16a (or a co-extruder) and a roller assembly 16b for calendaring an extrudate from the extruder. The extruder 16a may communicate with a material container 23 configured to receive a second material 5 comprising a thermoplastic material, preferably comprising thermoplastic polymers and a filler. For example, the second material 5 may be received via a hopper.

In some embodiments, and may be seen in, e.g., FIG. 1b, the substrate forming arrangement 16 may comprise a roller mill 25, preferably a two-roller mill, communicating with a material container 23, and optionally a roller assembly 16b. The substrate forming arrangement 16 may further comprise a mixer 24, such as a Banbury mixer or a kneader, located upstream from the roller mill 25, and preferably a heater 26 for heating the second material 5 received in the material container 23. The mixer 24 may comprise a rotatable mixing member 24a, e.g., comprising at least one rotor. Optionally, the mixer 24 and heater 26 may be combined. In some embodiments, heat may be provided by friction.

The roller assembly 16b in FIG. 1a or 1b may include at least three rolls, such as 4, 5 or 6 rolls, for example arranged vertically above or horizontally adjacent to each other. By means of the roller assembly 16b, the extrudate or the heated material from the roller mill 25, preferably in the form of a paste, may be calendared into a substrate 6 in the form of a, preferably continuous, sheet. The sheet may thereby obtain an essentially constant thickness.

The arrangement 20 may comprise an application device 28, such as at least one scattering device, configured to apply the first material 4 on the substrate 6, see, e.g., FIGS. 1a-1b and 3a-3c, or in the shaping units 11, such as on the shaping press plate 13a, see, e.g., FIGS. 4a-4c and 6b-6c.

The arrangement 20 may comprise a heating device 14 for heating the substrate 6 and/or the first material 4. In some embodiments, and as shown in, e.g., FIG. 1a, the heating device 14 may be provided in the substrate forming arrangement 16. For example, an extrudate from the (co-)extruder may be provided at an elevated temperature TS, such as 90-225° C., such as 145-220° C. In some embodiments, and as shown in, e.g., FIGS. 1a-1b and 3b, the heating device 14 may be a separate heating device, for example in the form of one or several tempered rollers, in the form of the heater 26, or in the form of an infrared heater. In a first example, the first and second rollers, and optionally the third roller, in the roller assembly 16b along the feeding direction F may be heated, see FIG. 1a or 1b. In a second example, the roller 17a may be heated and thereby provide a heating device 14. In some embodiments, the heating device 14 may be provided as a heating zone in the double-belt press, see FIGS. 3a-3c and 4a-4b.

It is clear that the substrate 6 disclosed herein, such as in any of FIGS. 1a-1c, 2a-2d, 3a-3c, 6b and 7d-7f, may be provided at the elevated temperature TS, such as by means of any of the alternatives in the previous paragraph.

Optionally, the arrangement 20 may comprise a pre-heater 14a adapted to pre-heat the first material 14a, such as an infrared heater, see, e.g., FIGS. 1a-1b and 3a.

Alternatively or additionally to the heating device 14, the arrangement 20 may comprise a cooling unit 15 and/or 15a, preferably arranged downstream of and/or at the heating device 14. There may be a cooling unit 15 arranged upstream of the shaping member 10 and/or a cooling unit 15a arranged downstream of or at the shaping member 10. The cooling unit 15, 15a may be provided in the form of one or several tempered rollers, see for example FIGS. 1a and 1c, may be separately arranged in the form of direct or indirect fluid cooling or in the form of air cooling, see for example FIGS. 1a and 1b, or it may be provided in the form of a cooling zone in a double-belt press, see for example FIGS. 3a-3c and 4a-4b. A cooling unit 15a may be provided by the roller 17b, by a cooling zone in the double-belt press, and/or by a separate cooling unit, optionally comprising rollers. A cooling unit 15a adapted to face a rear 6a and/or a front 6b side of the substrate 6 (see the dashed lines in FIGS. 1a and 1c) may be configured to cool the rear 6a and/or front 6b side.

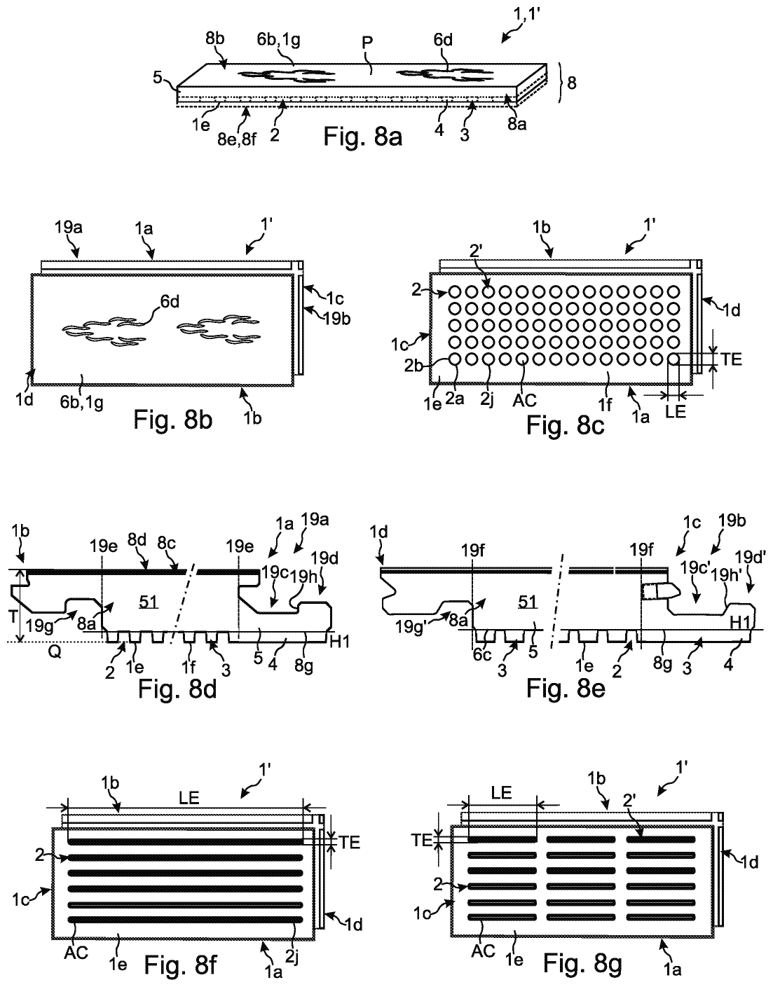

Optionally, the substrate forming arrangement 16 may comprise a top layer roller arrangement 22 comprising a decorative layer 22a and/or a wear layer 22b roller arrangement. Such a top layer roller arrangement 22 is shown in more detail in FIGS. 1a-1b, but is conceivable in any embodiment herein, such as in or in relation to any of FIGS. 1c, 3a-3c and 4a-4c. Thereby, a décor structure 8b, such as a decorative layer 8c and/or a wear layer 8d, may be continuously laminated to the board element 1 after or during its forming. The décor structure 8b may be applied to the substrate 6 or board element 1 under pressure from the rollers in the top layer roller arrangement 22, preferably without using an adhesive. Optionally, the board element 1 may be heated during the lamination, such as by IR heat or by means of one or several heated rollers in the top layer roller arrangement 22 and/or in the roller assembly 16b. In some embodiments, the décor structure 8b may be formed by, preferably digitally, printing a print P directly on the board element 1 or core 8a by means of a printer 22c and optionally providing a wear layer 8d thereon, cf., e.g., FIGS. 4a and 8a. In some embodiments, a backing layer 8e may be laminated to the substrate 6 or board element 1 before or after creating the cavity region 2, respectively.

At least one layer 8 may be in some embodiments laminated to the board element 1 in a pressing member 29, such as a static press or continuously using rollers, preferably under heat, see, e.g., FIGS. 1b and 2a-2b. The layer 8 may be a décor structure 8b and/or a backing layer 8e. Alternatively, the layer 8 may provide dimensional stability to the panel. For example, the layer 8 may be a mineral-based layer, preferably comprising magnesium oxide and optionally magnesium chloride (e.g., MgCl₂) and/or magnesium sulphate (e.g., MgSO₄).

In some embodiments, as shown in FIG. 1b, the arrangement 20 may further comprise a support member 18 adapted to support the rear side 6a, 1e, at least including an inner portion 2f of the created cavities 2′ and optionally a lower surface 3c of the formed protrusions 3. The cavities 2′ and/or protrusions 3 may be supported during lamination of a layer 8 to the substrate 6 or board element 1 and/or during cooling of the board element, such as of the front side 6b, 1g.

The support member 18 may comprise at least one protruding support element 7, preferably a plurality of them. PCT/SE2023/050596 discloses embodiments of such a support element 18 and its operation on page 12, lines 13-19, page 16, lines 20-26, page 20, lines 17-28, page 21, lines 1-9 and FIGS. 2a and 6a-6i, which parts hereby are explicitly incorporated by reference, including the passages about the abutment member 17 and the displaceability in a direction W.

As shown in, e.g., FIGS. 1a-1b, but is conceivable in any embodiment herein, the arrangement 20 may further comprise a board dividing device 21a and/or a profiling unit 21b. The board dividing device 21a may be configured to divide the board element 1 into at least one panel 1′, such as at least two panels 1′. The profiling unit 21b may be adapted to produce a locking device 19a, 19b on at least one edge portion 1a, 1b, 1c, 1d of the board element 1 in the form of a panel 1′ or at least one panel 1′ into which the board element has been divided. For example, a locking device 19a and/or 19b may be produced on long 1a, 1b and/or short 1c, 1d edge portions, preferably by machining.

As illustrated in, e.g., FIGS. 1b, 1d, 3a-3c, 4a and 8a, in some embodiments, the manufactured board element 1 or panel 1′ does not comprise a locking device. For example, they may be assembled in a loose-lay configuration, preferably in mutual abutment, or they may be attached to a subfloor by means of an adhesive.

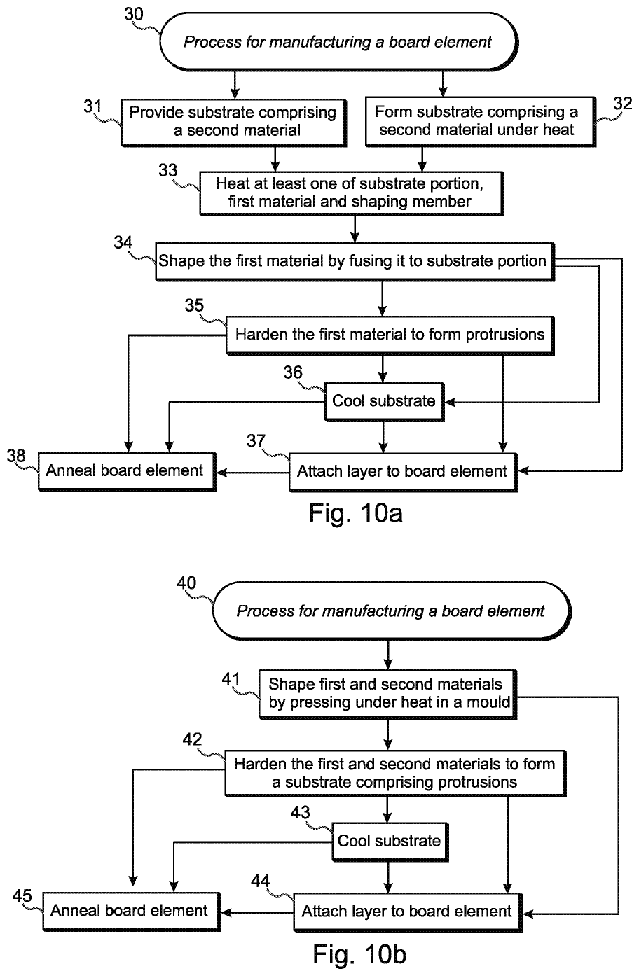

The arrangement 20 in, e.g., any of FIGS. 1a-1c, 2a-2h, 3a-3c, 4a-4c, 5a-5f, 6a-6c and 7d-7e, is capable of implementing a process for manufacturing a board element 1, such as a panel, comprising a cavity region 2 comprising at least one cavity 2′, preferably a plurality of cavities 2′, in a rear side 1e of the board element. The flow charts in FIGS. 10a and 10b illustrate embodiments of such a process (Box 30 or 40).

The board element 1 is manufactured from a first 4 and a second 5 material, each comprising a thermoplastic material. The first 4 and/or second 5 material(s) may comprise thermoplastic polymers, such as PVC, PE, PP, TPU, PET, EVA, PA, PS, PVAc, PMMA, PVB, PC, ABS, PAM, PBT, or CPVC, a filler, and optionally additives, such as at least one of a stabilizer, a blowing agent or a foaming agent, a plasticizer, a colourant, pigments, a lubricant, an impact modifier, a processing aid, etc.

Additives, such as a plasticizer and/or a lubricant, in the first material 4 may contribute to an increased flow of the material and hence a more controlled fusion or moulding may be obtained. The plasticizer, such as dioctyl terephthalate, DOTP, may soften the first material 4. The lubricant may be an internal lubricant, such as fatty alcohols or fatty glycerol esters, and/or an external lubricant, such as wax, e.g., a PE wax or a paraffin wax. For example, a degree of plasticizer may be 1-25 wt %, preferably 3-20 wt %, and/or a degree of lubricant may be 0.2-5 wt %, preferably 1-2 wt %. Moreover, additives, such as a processing aid, may be included for improving the fusion of the second material 5 during forming of the substrate 6 and/or for mitigating the formation of cracks during fusion or moulding. For example, a degree of processing aid, such as an acrylic processing aid, may be 0.5-5 wt %, preferably 1-3 wt %.

In some embodiments, the thermoplastic polymers of the first material 4 may comprise a PVC-PVAc copolymer and, optionally PVC. Thereby, the first material 4 may become softer and more easily processed, whereby the fusion or moulding may become simplified. For example, a degree of PVC/PVAc copolymer may be 5-100 wt %, preferably 8-25 wt %.

The components of the first 4 and/or second 5 material(s) may be provided as a mixture, such as a powder or a particulate, which before heating preferably is provided as a dry blend. Components of the powder (or particulate) may have an extension of 0.3-200 μm, such as 0.5-50 μm (or 0.2-3.0 mm, such as 0.3-1.5 mm), at least in one direction, such as in a maximal thickness direction, of the components, preferably in three perpendicular directions. Preferably, the thermoplastic material is homogeneously distributed in each of the first and/or second materials. Alternatively, and as illustrated in the embodiment in FIG. 4d, the first material 4 and/or the second material 5 may be provided as a composite, preferably pre-compounded, material, such as a granulate, pellets or a particulate, preferably comprising any of the thermoplastic polymers, filler, and optionally additives specified above. Components of the granulate or pellets may have an extension of 0.5-10 mm, preferably 1-3 mm and components of the particulate may have an extension of 0.2-3.0 mm, preferably 0.3-1.5 mm, at least in one direction, such as in a maximal thickness direction, of the components, preferably in three perpendicular directions. The composite material may increase the cohesiveness of the first material and/or may increase the adhesiveness between the first and second materials. The filler in any of these alternatives may comprise, or may be, an inorganic or organic filler, such as a mineral material, for example CaCO₃, limestone, such as chalk, talc, fly ash, BaSO₄, or a stone material, such as stone powder. Moreover, the first material 4 may comprise a functional filler, for example cork particles, hollow microparticles, such as hollow glass microspheres, fibers, such as organic fibres or inorganic fibres, or rubber particles.

In accordance with some embodiments, e.g., implemented by the arrangement 20 in any of FIGS. 1a-1c, 2a-2d, 3a-3c and 6b, a substrate 6 comprising a second material 5 comprising a thermoplastic material is first provided (Box 31) or formed under heat and, preferably, pressure and/or by (co-)extrusion (Box 32). In the former case, the thus provided substrate 6 may be preformed, preferably being absent of cavities 2′, and a substrate portion 6c comprising the second material 5 may optionally be heated by a heating device 14 (Box 33), such that the substrate portion 6c or even the entire substrate 6 including the second material 5 becomes disposed at an elevated temperature TS. On the other hand, when the substrate 6 is formed, the elevated temperature TS may be obtained during the forming. For example, the substrate 6 may be formed in a substrate forming arrangement 16.

The elevated temperature TS may exceed 40° C., preferably being 40-295° C., more preferably 100-295° C. When the thermoplastic material comprises PVC, the elevated temperature TS of the second material 5 may be 50-210° C., preferably 60-180° C., more preferably 110-180° C. When the thermoplastic material comprises PP, the elevated temperature TS may be 60-220° C., preferably 70-175° C., more preferably 100-175° C. When the thermoplastic material comprises PET, the elevated temperature TS may be 70-295° C., preferably 110-280° C., more preferably 130-280° C.

Thereafter, a first material 4 is shaped in shaping units 11 of a shaping member 10 (Box 34). The first material 4, which may be provided as a mixture or as a composite material, may be applied in a fusing device 11a comprising the shaping units 11 or on the substrate 6 by the application device 28, such as by scattering, cf. FIGS. 1a-1c, 2a-2d, 3a-3c, 4c and 6b. For example, it may be applied in the shaping units 11 and optionally between them, above the protruding elements 9. The first material 4 may be fused to a substrate portion 6c (Box 34) by applying heat and, optionally, pressure to the first material, such as in the fusion device 11a, cf. FIGS. 1a-1c, 2a-2d, 3a-3c and 6b. Preferably, the first material 4 is heated, optionally including a step of pre-heating, to a temperature T1 of 80-295° C., before and/or during shaping thereof (Boxes 33 and 34). For example, it may be heated by a heating device 14 and optionally pre-heated by a pre-heater 14a. The applied pressure may be in the range of 0.4-6.0 MPa, such as 0.5-5.0 MPa or 0.6-3.0 MPa. For example, the applied pressure may be 0.7-2.5 MPa, such as 1.0-2.0 MPa. The shaped first material 4 is thereafter hardened (Box 35), optionally under pressure, to form protrusions 3 fused to a rear side 6a of the substrate 6. The protrusions 3 may thereby be formed on the rear side 6a. The substrate 6 may be cooled by a cooling unit 15a and/or hardened to form a core 8a.

In view of the above, a board element 1 comprising a cavity region 2 created, preferably horizontally, between the protrusions 3 may be obtained, see, e.g., FIGS. 1a-1c, 2a-2d, 3a-3c, 6d, 7a-7b and 7g.

In accordance with some embodiments, the substrate 6 and the protrusions 3 may be formed simultaneously, preferably as a continuous layer. The first 4 and second 5 materials, which each may be provided as a mixture or as a composite material (see above), may be applied in a mould 11b comprising shaping units 11 by the application device 28, such as by scattering, cf. FIGS. 4a-4b and 6c. Preferably, the first 4 and second 5 materials are applied in the shaping units 11 and in a mould body 11c, respectively. The mould body 11c may be provided between the protruding elements 9 and the mating member 12, such as vertically above the protruding elements 9 and vertically below the mating member 12, and may be configured to mould a core 8a of the board element 1 or panel 1′. The first 4 and second 5 materials may be moulded under pressure and heat (Box 41), such as in a pressing device. Hence, the moulding may comprise shaping, heating, and pressing of the first 4 and second 5 materials. The materials 4, 5 may be heated, preferably to a temperature T1, T2 of 80-295° C., before and/or during the moulding. The applied pressure may be in the range of 0.4-6.0 MPa, such as 0.5-5.0 MPa or 0.6-3.0 MPa. For example, the applied pressure may be 0.7-2.5 MPa, such as 1.0-2.0 MPa. The moulded first 4 and second 5 materials are thereafter hardened (Box 42), optionally under pressure, to integrally form a substrate 6 and protrusions 3 in a rear side 6a thereof. The substrate 6 and the protrusions may be cooled by a cooling unit 15a and/or hardened to form a core 8a.

In view of the above, a board element 1 comprising a cavity region 2 created between the protrusions 3 may be obtained, see, e.g., FIGS. 4a, 6e, 7c and 7g.

Optionally, the substrate 6 may be displaced in a feeding direction F during the forming of protrusions 3, see, e.g., FIGS. 1a-1c, 3a-3c and 4a-4b. For example, the substrate may be fed along the longitudinal X and/or vertical Z direction(s).

When the first material 4 comprises PVC, and, preferably a filler, it may be heated to 80-210° C., preferably 100-180° C. When the first material 4 comprises PP, and, preferably a filler, it may be heated to 80-220° C., preferably 90-175° C. When the first material 4 comprises PET, and, preferably a filler, it may be heated to 90-295° C., preferably 120-280° C. It is emphasized that any of these temperatures are conceivable for the first material 4 in the case of fusion (T1) as well as for the first 4 and/or the second 5 material in the case of moulding (T1 and/or T2).

In some embodiments, the fused or moulded first 4 and second 5 materials may be of the same or of substantially the same type. The materials 4, 5 may have substantially the same grade, density, amount and type of filler, amount and type of additives. For example, the first and second materials may be identical. Thereby, the bonding between the protrusions 3 and the substrate 6 may become improved.

In some embodiments, the fused or the moulded first 4 and second 5 materials may be of different types. In an example related to fusion, a first material 4 of a type different than the type of material of the substrate 6 may be fused to the substrate portion 6c. In an example related to moulding, the first 4 and second 5 materials may be applied, such as scattered, in the shaping units 11 and in the mould body 11c, respectively. For example, the shaping units 11 and the mould body 11c may comprise 10-100 wt %, preferably 50-100 wt %, more preferably 70-100 wt %, of the first 4 and second 5 material, respectively, wherein the remaining part of the shaping units and mould body consists of the second material 5 and first 4 material, respectively.

For example, the materials 4, 5 may differ by at least one element selected from the group of polymers, a grade, a density, an amount of filler, a type of filler, an amount of additives, and a type of additives. Thereby, the properties of the protrusions 3 and the substrate 6 may be different, and the properties of the board element 1 as a whole may be adapted to an environment in which it is to be installed. It is emphasized that in some embodiments, the thermoplastic material of the first and second materials may be based on the same polymer, such as PVC, but may differ by at least one element selected from the group of a grade, a density, an amount of filler, a type of filler, an amount of additives, and a type of additives. For example, the first material 4 may comprise a functional filler, for example cork particles, hollow microparticles, such as hollow glass microspheres, fibers, such as organic fibres or inorganic fibres, or rubber particles.

In some embodiments, the substrate 6 may be cooled (Box 36 or 43). In particular, a front side 6b of the substrate 6 may be cooled during and/or after the hardening of the first material 4, preferably by means of a cooling unit 15a adapted to face the front 6b side, see, e.g., FIGS. 1a-1c, 3a-3c and 4a-4b. Thereby, a crust layer may be provided.

Alternatively, or additionally, the rear side 6a, preferably a lower surface 3c of the protrusions 3, may be cooled. The lower surface 3c may be part of a lowermost portion of the rear side 6a. For example, a heating device 14 and a cooling unit 15a provided by the rollers 17a and 17b, respectively, may be utilized, see FIG. 1a. Alternatively, or additionally, a cooling unit 15a adapted to face the rear 6a may be used. When both the rear 6a and front 6b sides are cooled, the front side 6b is preferably cooled more than the lower surface 3c. Preferably, there is no direct cooling of the inner portion 2f of the cavities 2′. In some embodiments, the entire substrate 6, including front side 6b and the lower surface 3c, may be cooled.

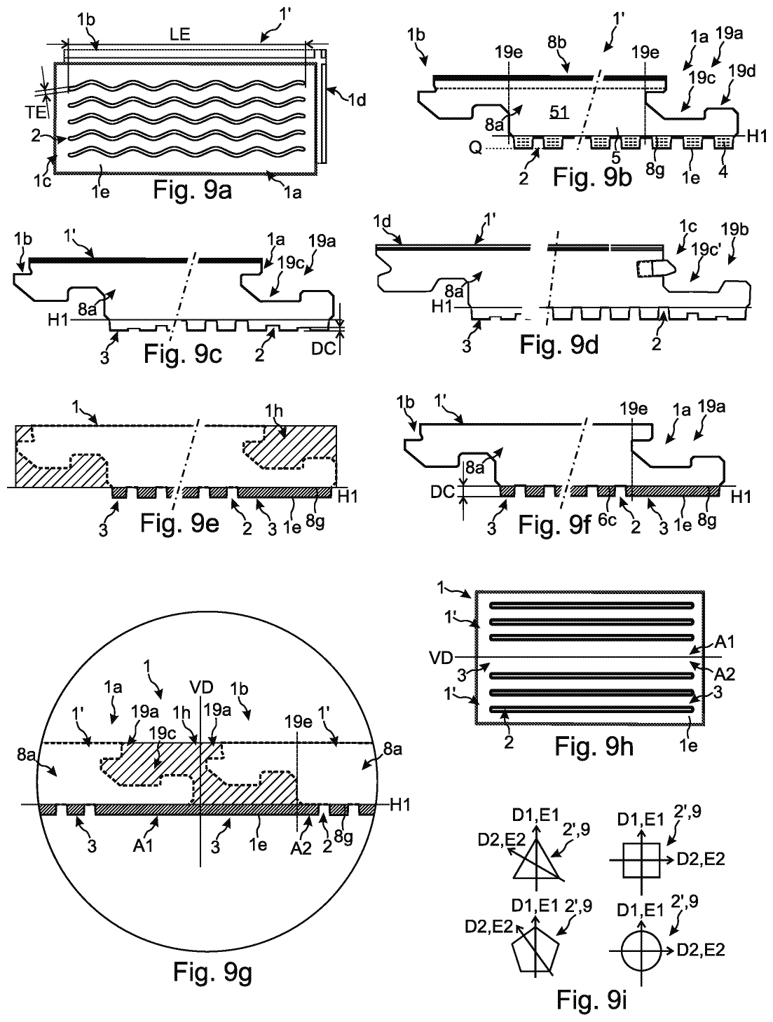

In some embodiments, the process may comprise forming at least one chamfer 2a, 2b in the cavities 2′. The chamfers, such as an outer 2a and/or an inner 2b chamfer, may be formed by the bevels, such as the inner 9b and/or outer 9a bevels, of the protruding elements 9. The chamfers 2a, 2b may be provided along a longitudinal LE and/or a transverse TE extension (see FIGS. 8f-8g and 9a) of the cavities 2′, such as along their entire circumference 2j. Each chamfer 2a, 2b may be disposed between a cavity wall 2c and the rear side 6a, 1e or between the cavity wall 2c and a bottom wall 2d of the cavity 2′. The chamfer 2a, 2b may be inclined with respect to a normal direction M of the substrate 6 or board element 1 by a chamfer angle γ, see, e.g., FIGS. 7d and 7f. The chamfer angle γ may be 10-70°, such as 25-40°, for example 45°. The bevel 9a, 9b and/or chamfer 2a, 2b may be substantially planar (see FIG. 7d) or rounded (see FIG. 7f and the broken line at 9a in FIG. 7d), such as comprising a radius RB. An extension of a substantially planar bevel and/or substantially planar chamfer may be 0.07-2 mm, such as 0.1-1 mm. For the rounded bevel or rounded chamfer, the radius RB may be 0.05-2.5 mm, such as 0.1-1.2 mm.

More generally, the process may comprise creating tapering cavities 2′ by means of tapering protruding elements 9, see, e.g., FIG. 7e. The cavities 2′ may taper along their longitudinal LE and/or transverse TE extension(s). A cavity wall 2c may be inclined with respect to the normal direction M by a wall angle δ, see, e.g., FIG. 7e. The wall angle δ may exceed 0.5°, such as exceeding 1.0° or even exceeding 3.0°. Alternatively, or additionally, the wall angle δ may be less than 80°, such as being less than 70°, or even less than 50°. For example, the wall angle δ may be 0.5-70°, such as 0.5-45° or 1-30°. Alternatively, or in addition, to the tapering cavity wall 2c, the tapering cavities 2′ may comprise a chamfer 2a, 2b described above.

Generally herein, a form of the cavities 2′ may correspond to a form of the protruding elements 9. For example, the draft angle α and the wall angle δ may correspond to each other and/or the bevel angle β and the chamfer angle γ may correspond to each other.

Optionally, a layer 8 may be attached, such as laminated or adhered, to the substrate 6 or board element 1 (Box 37 or 44), see, e.g., FIGS. 1a-1b, 2a, 2d and 6b-6c. In some embodiments, as shown in FIG. 1b, a layer 8 may be attached to the substrate 6 while forming the protrusions 3 and hence creating the cavity region 2. The layer 8 may be a décor structure 8b, such as such as a decorative layer 8c and/or a wear layer 8d, and/or a backing layer 8e, see, e.g., FIGS. 6d-6e, 7a-7c, 7g, 8a-8e and 9b-9f. Optionally, the rear side 6a, 1e, at least including an inner portion 2f of the created cavities 2′ and optionally a lower surface 3c of the formed protrusions 3 may be supported during attachment of the layer 8 to the substrate 6 or board element 1, cf. FIG. 1b herein and FIGS. 2a and 6a-6h of PCT/SE2023/050596 referred to above.

As an alternative or complement to supporting the rear side 6a, 1e during attachment of the layer 8, the substrate portion 6c or the board element 1 may be cooled after creating the cavity region 2 and before attaching the layer 8, see, e.g., FIG. 2a in PCT/SE2023/050596 referred to above.

The board element 1 herein may be provided in the form of a panel 1′ or may dividable into at least one panel 1′, such as at least two panels, wherein each panel is a building panel, floor panel, wall panel, ceiling panel or furniture component. In fact, embodiments of the process disclosed herein (see, e.g., Box 30 or 40) may further comprise dividing the board element 1 into at least one panel, such as at least two panels 1′, by a board dividing device 21a, cf. FIGS. 1a-1b. For example, the board element 1 may be divided into board members 1″ by a first dividing unit 21a′, which in turn may be further divided into at least two panels 1′ by a second dividing unit 21a″, wherein the panels preferably are divided into a substantially final format. Preferably, the board element 1 or board member 1″ is divided while provided above an initial temperature of the substrate 6 and/or an ambient temperature.

Alternatively, or additionally, the process may further comprise producing a locking device 19a, 19b on at least one edge portion 1a, 1b, 1c, 1d by the profiling unit 21b. The locking device 19a, 19b may be configured to provide horizontal and/or vertical locking of the edge portion to an edge portion of an adjacent panel 1′. Preferably, the locking device 19a, 19b is produced on two opposite edge portions of the panel(s) 1′. As illustrated in FIGS. 9e-9g, a locking device 19a and/or 19b may be produced in a panel 1′ comprising a cavity region 2 and protrusions 3 by removing board material 1h, such as by machining.

In some embodiments, and as illustrated in FIGS. 9g-9h, the board element 1 may comprise a protrusion 3 extending at a dividing portion VD of the board element at which it is adapted to be divided into a first and a second panel 1′. Thereby, before dividing, a single protrusion 3 may extend under both of the edge portions 1a, 1b of the first and second panels, such that this single protrusion 3 may split into two protrusions 3 after the dividing, which are arranged under a respective edge portion 1a, 1b. Preferably, the protrusion 3 extends from an area A1 under a strip 19c of the first panel to be produced to an area A2 disposed horizontally inwardly of a horizontally innermost portion 19e of the locking device 19a of the second panel to be produced. After dividing the board element, a locking device 19a may be produced at the edge portions 1a, 1b of the first and second panels by removing board material 1h, such as by machining. Thereby, a first and a second panel 1′ with edge portions 1a, 1b such as those in FIG. 9f may be obtained.

FIGS. 9e-9h illustrate long edge portions 1a, 1b, but it is emphasized that similar dividing processes are equally conceivable for dividing the board element 1 and producing a locking device 1b at short edge portions 1c, 1d of a panel 1′, cf. FIGS. 8b-8c, 8e-8g and 9d (with a strip 19c′ and a horizontally innermost portion 19f).

In some embodiments, the arrangement 20 may further comprise an annealing unit 21c, preferably arranged after at least a part of the board dividing device 21a and before the profiling unit 21b, see, e.g., FIGS. 1a-1b. In a non-restrictive example, and as is most clearly seen in FIG. 1a, the annealing unit 21c may be arranged after the first dividing unit 21a′ and before the second dividing unit 21a″. When the substrate 6 is cooled by a cooling unit 15, 15a, the annealing preferably is performed after the cooling.

Thus, the board element 1 may optionally be annealed (Box 38 or 45) after forming the protrusions 3. The annealing may comprise heating the board element 1 or board member 1″ to an annealing temperature of 80-170° C., such as 120-145° C., such as 130-140° C. For example, the annealing temperature may be below the glass-transition temperature T_{g} of both the first material and the second material. For example, the first material 4, and optionally the second material 5, may comprise PVC and a filler, such as an inorganic filler.

By way of example, the annealing unit 21c may comprise at least one of a heat oven, a hot-air heater, and a heat bath comprising a fluid, such as water.

FIGS. 1d, 3a-3c, 4a, 6d-6e, 7a-7c, 7f-7g, 8a-8g and 9a-9i illustrate embodiments of a board element 1, such as a panel 1′, obtainable by the process described herein, such as by fusion or moulding. The board element 1 or panel 1′ comprises at least one layer 8, such as a core 8a, comprising a second material 5 and a cavity region 2 provided between protrusions 3 formed in the rear side 1e, wherein the protrusions comprise a first material 4.

The protrusions 3 may be provided below an underside 8g of a core 8a (or substrate 6). For example, the protrusions 3 may protrude vertically downwards from the underside 8g. The core 8a (or substrate 6) and the protrusions 3 may extend above and below a horizontal plane H1, respectively. Thereby, the first 4 and second 5 materials may share and/or may be bonded along an attaching area 50, preferably along the horizontal plane H1. For example, at least an inner zone 51 of the substrate 6 or core 8a of the board element 1 or panel 1′ may be substantially shaped as a rectangular parallelepiped, see, e.g., FIGS. 6d-6e, 7a-7c, 8d-8e and 9b-9g, optionally in addition including inner sections 3d of the protrusions 3, see, e.g., FIG. 7g. The inner zone 51 may be arranged between the horizontal plane H1 and the front side 6b of the core (or substrate), and for a panel 1′ it may in addition preferably be arranged between the horizontally innermost portions 19e and/or 19f. The horizontal plane H1 may extend along an underside 8g of the core 8a (or substrate 6) and may be a substantially planar surface. The horizontal plane H1 may be parallel with the front 6a and/or the rear 6b side.

In FIG. 7g, the inner sections 3d comprise the second material 5 and outer sections 3e of the protrusions comprise the first material 4.

Generally, the board element 1 or panel 1′ may be multi-layered, e.g., obtained from co-extrusion or from attaching, such as laminating, layer(s) 8 to a core 8a. For example, the board element or panel may comprise a core 8a and a décor structure 8b, such as a decorative layer 8c and/or a wear layer 8d. The decorative layer and/or wear layer may be provided as a thermoplastic-based foil or film, for example comprising PVC. A thickness of the decorative layer and wear layer may be 0.01-0.10 mm and 0.05-2.0 mm, respectively. In some embodiments, the décor structure 8b may comprise an embossing 6d, see FIGS. 8a-8b. Optionally, the panel may further comprise a backing layer 8e and/or a cover layer 8f, such as a foam layer.

The first 4 and/or the second 5 material, and hence any, some, or each layer 8, 8a, 8b, 8c, 8d, 8e, 8f, may comprise thermoplastic polymers, such as PVC, PE, PP, TPU, PET, EVA, PA, PS, PVAc, PMMA, PVB, PC, ABS, PAM, PBT, or CPVC, and a filler. For example, the filler may comprise, or may be, an inorganic filler, such as a mineral material, or a functional filler, for example cork particles, hollow microparticles, fibers, such as organic fibres or inorganic fibres, or rubber particles. The microparticles, such as glass bubbles, may comprise at least one selected from the group of silicon dioxide, aluminium oxide, soda lime, borosilicate, soda lime-borosilicate, and zirconia. Each microparticle may have an extension of 5-200 μm, such as 10-100 μm, in at least one direction of the microparticle, such as in three perpendicular directions thereof. Generally herein, the first 4 and/or the second 5 material may further comprise additives, such as at least one of a stabilizer, a blowing agent or a foaming agent, a plasticizer, a colourant, pigments, a lubricant, an impact modifier, a processing aid, etc. For example, a layer 8 of the panel 1, such as the core 8a, e.g., obtainable by embodiments of the process described herein, may comprise 10-40 wt % PVC, 50-90 wt % inorganic filler, such as chalk, and 0-20 wt %, such as 5-20 wt %, additives.

In any of the embodiments of the substrate 6 or board element 1, such as panel 1′, herein, a surface of an inner portion 2f, such as of the cavity wall 2c and/or the bottom wall 2d, of the cavities 2 may be closed. Such a closed surface is defined on page 31, line 20 to page 32, line 2 in PCT/SE2023/050596 which parts are explicitly incorporated herein by reference.

In some embodiments, and as shown, e.g., in FIGS. 8c-8g and 9d-9g, the cavity region 2 may be provided in an interior 1f of the rear side 1e, whereby the cavities 2′ may be spaced from a pair of opposite long edge portions 1a, 1b and/or from a pair of opposite short edge portions 1c, 1d. Optionally, they may be spaced from all edge portions of the panel as shown in FIGS. 8c-8g. The cavities 2′ may be provided inside of the locking device(s) 19a and/or 19b, as shown in, e.g., FIGS. 8c-8g and 9a. For example, the cavities 2′ may be provided inside of horizontally innermost portions 19e, 19f of the locking device(s) 19a and/or 19b.

A protrusion 3 may be arranged at least partly under the locking device(s) 19a and/or 19b. In particular, a protrusion 3 may be provided under, preferably directly vertically under, a strip 19c, 19c′ extending horizontally from a lower portion of the board element 1 or panel 1′, such as provided on the long 1a and/or the short 1c edge portion. A locking element 19d, 19d′ may be provided on the strip 19c and/or 19c′ and may be configured to cooperate with a locking groove 19g and/or 19g′ of an adjacent panel 1′ for horizontal locking. The protrusion 3 may be provided under, preferably directly vertically under, a locking surface 19h, 19h′ of the locking element 19d, 19d′. For example, the protrusion 3 may extend along substantially an entirety of the strip 19c, 19c′, e.g., at least to the horizontally innermost portion 19e, 19f, see, e.g., FIGS. 8c-8e.

The protrusions 3 may in some embodiments be at least partially separated from each other. In some embodiments, and as shown in, e.g., FIGS. 7a and 7g, the protrusions 3 may be entirely separated from each other (discontinuously), such as along one direction or along two perpendicular directions. In FIG. 7a, the protrusions 3 may extend vertically to the horizontal plane H1 and in FIG. 7g, the protrusions 3 may extend vertically below the bottom wall 2d of the cavities 2′.

In some embodiments, and as shown in, e.g., FIGS. 6d-6e and 7b-7c, an intermediate portion 3b, which, e.g., may be a strip or a film, may extend between the protrusions 3, such as an inner section 3d thereof. A thickness K of the intermediate portion 3b may be 0.1-3.0 mm, such as 0.3-2.0 mm. For example, a pair of adjacent protrusions 3 may be continuously joined to each other via an intermediate portion 3b. A surface of the intermediate portion 3b may comprise an inner portion 2f of the cavities 2′. In some embodiments, the intermediate portion 3b together with an area 3a provided above the protrusions 3 may form the entire substrate 6 or core 8a, see, e.g., FIGS. 6e and 7c.

As shown in FIGS. 2e-2h, 5a-5d, 6a-6c and 9i, extensions of the protruding elements 9 along a pair of non-parallel, such as perpendicular, horizontal directions E1, E2 may be substantially the same. Generally herein, the horizontal extensions E1, E2 may be determined at the base of the protruding element. Thereby, circumscribed cavities 2′ may be created having extensions along a pair of non-parallel, such as perpendicular, horizontal directions D1, D2 that are substantially the same. For example, the cavities 2′ may have a boundary shaped as a circle or a, preferably regular convex, polygon, such as a triangle, square, pentagon, hexagon, etc., see FIGS. 8c-8e, 9b-9d and 9i. The horizontal extensions E1, E2 may have components along the X and Y directions during shaping.

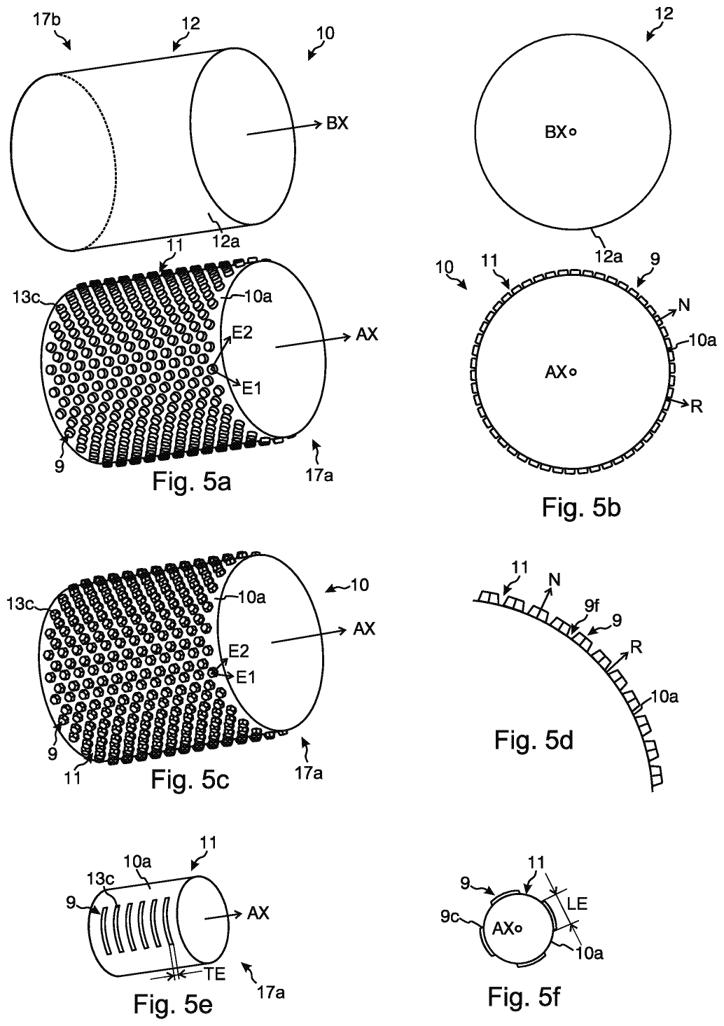

As shown in FIGS. 5e-5f, the protruding elements 9 may in some embodiments be horizontally elongated, whereby horizontally elongated cavities 2′ may be created, see, e.g., FIGS. 8f-8g, 9a and 9g. Thereby, the protruding elements 9 and the cavities 2′ may have a longitudinal extension LE which is larger than transverse extension TE. The elongated protruding elements 9 may be provided along a part of the base portion 10a, such as along a circumference thereof, cf. FIG. 5f. The elongated cavities 2′ may be essentially straight as shown in FIGS. 8f-8g and 9h or may have a curved or non-linear shape, such as a waveform, see FIG. 9a. The elongated cavities 2′ may be substantially parallel with the long edge portions 1a, 1b. For example, the longitudinal extension of the cavities 2′ may be parallel with the long 1a, 1b or short 1c, 1d edge portions. In any of the embodiments herein, the elongated cavities 2′ may be continuous, as shown, e.g., in FIGS. 8f, 9a and 9g, or discontinuous, as shown, e.g., in FIG. 8g.

Generally herein, e.g., in FIGS. 5e-5f, 6d-6e, 7a-7c, 7g, 8f-8g and 9a-9h, a ratio between the longitudinal LE and transverse TE extensions of the elongated cavities 2′ and/or the elongated protruding elements 9 may be 1<LE/TE≤150, such as 6≤LE/TE≤120, preferably 10≤LE/TE≤100. For the protruding elements, TE and LE may be measured along the base portion 10c, such as along the circumference (cf. FIG. 5f).

The cavities 2′, for example in any of FIGS. 6d-6e, 7a-7c, 7g, 8a-8g and 9a-9i, may comprise at least one chamfer 2a, 2b as has been detailed elsewhere herein. Examples of such chamfers provided along the longitudinal LE and/or transverse TE extension(s) are shown in FIGS. 7d and 7f. For example, the chamfers in an elongated cavity 2′ may be provided along its longitudinal extension LE and, optionally, along its transverse extension TE. The chamfer may sometimes be provided along an entire circumference 2j of the cavity 2, see, e.g., FIGS. 8c and 8f and cf. FIGS. 2e-2h.

Alternatively, or additionally, the cavities 2′ in any of FIGS. 6d-6e, 7a-7c, 7g, 8a-8g and 9a-9i may taper as has been detailed elsewhere herein. Examples of such tapering cavities comprising inclined cavity wall(s) 2c along the longitudinal LE and/or transverse TE extension(s) are shown most clearly in FIGS. 7e, 8d-8e and 9b-9g.

Generally, the substrate 6, core 8a, or board element 1, such as the panel 1′, herein, may have a, preferably maximal, thickness T of 2-10 mm. Moreover, a depth DC of the cavities 2′, preferably of a majority (i.e., more than 50%) thereof, may be 10-65%, such as 20-50%, of the thickness T.

In some embodiments, the depth DC of the cavities 2′ may be smaller at the long 1a, 1b and/or short 1c, 1d edge portions, for example at the locking device 19a and/or 19b, than in the interior 1f, cf. FIGS. 9c-9d. For example, they may become gradually smaller toward the edge portion(s). Thereby, the locking device may become stronger and/or a more rigid board element section may be provided.

In any of the embodiments herein, such as in FIGS. 1a-1d, 2a-2d, 3a-3c, 4a-4d, 6b-6e, 7a-7g, 8a-8g and 9a-9i, the first 4 and second 5 materials may be of substantially the same type. Furthermore, as indicated in, e.g., FIGS. 9b and 9e-9g, but which is conceivable in any of the previously listed embodiments, the first 4 and second 5 materials may be of different types.

Generally herein, e.g., in FIGS. 6d-6e, 7a-7c, 7g, 8a-8g and 9a-9f, at least half of the cavities 2′ provided in the rear side 1e, preferably all of them, may have essentially the same area AC. The area AC may be specified along a horizontal plane Q extending along the rear side 1e.

Aspects of the disclosure have mainly been described above with reference to a few embodiments. However, as is readily appreciated by a person skilled in the art, other embodiments than the ones disclosed above are equally possible within the scope of the disclosure. For instance, injection moulding is included in the concept of moulding herein. For example, the first 4 and second 5 materials, preferably of the same type, may be injection moulded for forming a substrate 6 and protrusions 3. Moreover, it is clear that the arrangement 20 in FIGS. 1a-1c, 2a-2d, 3a-3c and 4a-4c are exemplary and that elements therein, which may sometimes be left out, such as a pre-heater 14a or a cooler 15, 15a, are conceivable also in the other embodiments.

### Example

The forming of protrusions by fusion was tested by applying a first material in and between shaping units of a shaping press plate, similarly to the schematic illustration in FIG. 2a. A release spray was applied in and between the shaping units and a release foil was arranged on a pressing surface of a mating member. In a first set of tests, the first material was provided as a dry blend of powder and in a second set of tests the first material was provided as a pre-compounded granulate, which had been grinded from extruded pellets formed from the same dry blend of powder as in the first set. The dry blend comprised a PVC powder having an average size of 500 nm and chalk having an average size of 20 micron, and in addition comprised a stabilizer, internal and external lubricants, an impact modifier, and a processing aid. The first material together with the shaping press plate was pre-heated for 10 minutes in the first (or second) set of tests until they acquired a temperature of 180-200° C. (or 160-200° C.). The first material and a sample of an SPC panel and was then pressed for 5 minutes (or 2-5 minutes) with a pressure of 2-3 MPa in a static hot-hot press. Samples with identically formed protrusions of the type shown in FIG. 7b were then obtained for the first and second sets and the samples were passively cooled down to room temperature.

It was found that the protrusions and the intermediate portions in the second set of tests were more cohesive than in the first set of tests. Additionally, it was found that the adhesion of the protrusions and the intermediate portions to the samples was stronger in the second set than in the first set.

### EMBODIMENTS

Further aspects of the disclosure are provided below. Embodiments, examples etc. of these aspects are largely analogous to the embodiments, examples, etc. as described above, whereby reference is made to the above for a detailed description.

Item 1. A panel (1′) comprising a rear side (1e), the panel comprising:
a cavity region (2) provided between protrusions (3) formed in the rear side (1e), the protrusions comprising a first material (4) comprising a thermoplastic material, and
a core (8a) comprising a second material (5) comprising a thermoplastic material, wherein the first (4) and second (5) materials preferably are of different types.

Item 2. The panel according to item 1, wherein the first (4) and second (5) materials comprise different types of thermoplastic materials.

Item 3. The panel according to item 1 or 2, wherein the first (4) and second (5) materials differ by at least one element selected from the group of polymers, a grade, a density, an amount of filler, a type of filler, an amount of additives, and a type of additives.

Item 4. The panel according to any of the preceding items, wherein the protrusions (3) are provided below an underside (8g) of the core (8a), the underside being a substantially planar surface.

Item 5. The panel according to any of the preceding items, wherein the first material (4) comprises a functional filler, for example cork particles, hollow microparticles, fibers, such as organic fibres or inorganic fibres, or rubber particles.

Item 6. The panel according to any of the preceding items, wherein the first (4) and/or the second (5) material are formed from a granulate, pellets, a powder, or a particulate.

Item 7. The panel according to any of the preceding items, wherein the protrusions (3) are formed by fusion or by moulding.

Item 8. The panel according to any of the preceding items, wherein a protrusion (3) is arranged at least partly under a locking device (19a, 19b) of the panel (1′).

Item 9. The panel according to any of the preceding items, wherein said cavity region (2) is provided in an interior (1f) of the rear side (1e) being spaced from a pair of opposite edge portions (1a, 1b; 1c, 1d), such as opposite short edge portions, of the panel, optionally being spaced from all edge portions of the panel.

Item 10. The panel according to any of the preceding items, further comprising a décor structure (8b), such as a decorative layer (8c) and/or a wear layer (8d).

Item 11. The panel according to any of the preceding items, wherein any layer (8; 8a, 8b, 8c, 8d, 8e, 8f), some layers, or each layer of the panel comprises a thermoplastic material (4).

Item 12. The panel according to any of the preceding items, wherein extensions of cavities (2′) in the cavity region (2) along a pair of non-parallel, such as perpendicular, horizontal directions (D1; D2) are substantially the same.

Item 13. The panel according to any of the preceding items, wherein cavities (2′) in the cavity region (2) are horizontally elongated.

Item 14. The panel according to any of the preceding items, wherein the first (4) and second (5) materials are of the same type.

1. A process for manufacturing a board element comprising a thermoplastic material, a rear side of the board element comprising a cavity region, wherein the process comprises:
shaping a first material in shaping units of a shaping member, said first material comprising a thermoplastic material,
heating the first material, and
hardening the shaped first material for forming protrusions in a rear side of a substrate, wherein the substrate comprises a second material comprising a thermoplastic material,
thereby obtaining a board element comprising said cavity region created between the protrusions,
wherein the first and/or the second material is provided as a granulate, pellets, a powder, or a particulate.

2. The process according to claim 1, wherein the first material is heated to a temperature of 80-295° C.

3. The process according to claim 1, further comprising applying pressure to the first material during said shaping and/or during said hardening.

4. The process according to claim 3, wherein the applied pressure is in the range of 0.4-6.0 MPa.

5. The process according to claim 1, wherein the first material is fused to a substrate portion of the substrate by a fusing device included as part of the shaping member.

6. The process according to claim 1, wherein said acts of shaping and heating the first material are included in an act of pressing the first and second materials under heat for forming the substrate and the protrusions, and wherein the process further comprises hardening the second material.

7. The process according to claim 1, wherein the shaping member comprises a shaping press plate provided with a structured surface comprising said shaping units.

8. The process according to claim 1, further comprising cooling a front side of the substrate during and/or after said hardening of the first material.

9. The process according to claim 1, comprising cooling a lower surface of the protrusions.

10. The process according to claim 1, wherein components of the granulate, pellets, powder, or particulate have an extension of 0.3 μm to 10 mm, at least in one direction of the components.

11. The process according to claim 1, wherein extensions of protruding elements arranged between the shaping units along a pair of non-parallel horizontal directions are substantially the same.

12. The process according to claim 1, wherein protruding elements arranged between the shaping units are horizontally elongated.

13. The process according to claim 1, further comprising forming the substrate under heat.

14. The process according to claim 1, further comprising attaching a layer to the board element.

15. The process according to claim 1, further comprising annealing the board element after forming the protrusions.

16. The process according to claim 1, wherein the first material comprises a plasticizer.
